(19) United States
(12) Patent Application Publication
(10) Pub. No.: US 2026/0095965 A1
(43) Pub. Date: Apr. 2, 2026

(54) DATA PROCESSING APPARATUS AND METHOD

(71) Applicant: BLECON LTD, Cambridge Cambridgeshire (GB)

(72) Inventors: Simon Andrew Ford, Cambridge Cambridgeshire (GB); Nicholas CHEN, Cambridge Cambridgeshire (GB)

(21) Appl. No.: 19/343,815

(22) Filed: Sep. 29, 2025

(30) Foreign Application Priority Data
Oct. 2, 2024 (GB) 2414489.1

(51) Int. Cl. H04W 76/14

(52) U.S. Cl. CPC H04W 76/14

(57) ABSTRACT

A computer-implemented method for controlling a data processing apparatus, the method comprising: controlling, in response to opening of a uniform resource locator, URL, by a software application executed by the data processing apparatus, the data processing apparatus to perform a Bluetooth operation; and sharing information associated with the Bluetooth operation with the software application or a server apparatus of the software application.

### CROSS-REFERENCE TO RELATED APPLICATIONS

This application claims the benefit of and priority to GB 2414489.1, filed Oct. 2, 2024, titled “DATA PROCESSING APPARATUS AND METHOD,” the entire contents of which are hereby incorporated herein by reference.

### BACKGROUND

The present disclosure relates to a data processing apparatus and method. The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

Modern communication devices, in particular those which communicate using the various Bluetooth® standards, are becoming increasingly common. As the number of such devices increases, new services are being developed. Such services are often implemented using suitable software applications (e.g. mobile or web apps), for example, and typically require Bluetooth operations to be performed with the devices.

Currently, such Bluetooth operations are implemented using a standalone solution implemented by each service. This is inconvenient for service providers, who must spend time and effort configuring the Bluetooth operation functionality in the software application(s) delivering the service. It also means effort is duplicated by different parties in configuring similar Bluetooth operations for different services. There are also potential performance, user experience, security and/or complexity issues which arise from each service provider having to configure their own Bluetooth operations. For example, if a service provider's specialty relates to how sensor data from different devices is used rather than on efficient and secure Bluetooth operations, the Bluetooth operations implemented by the service provider may not be particularly efficient, user friendly or secure.

There is a desire to address these problems.

### BRIEF DESCRIPTION OF THE DRAWINGS

Non-limiting embodiments and advantages of the present disclosure are explained with reference to the following detailed description taken in conjunction with the accompanying drawings, wherein:

FIGS. 1A and 1B schematically show example data processing apparatuses;

FIG. 2 schematically shows an example process;

FIG. 3 schematically shows example graphical user interfaces;

FIG. 4 shows an example data flow;

FIG. 5 schematically shows a generalised example; and

FIG. 6 shows an example method.

Like reference numerals designate identical or corresponding parts throughout the drawings.

### DETAILED DESCRIPTION OF THE EMBODIMENTS

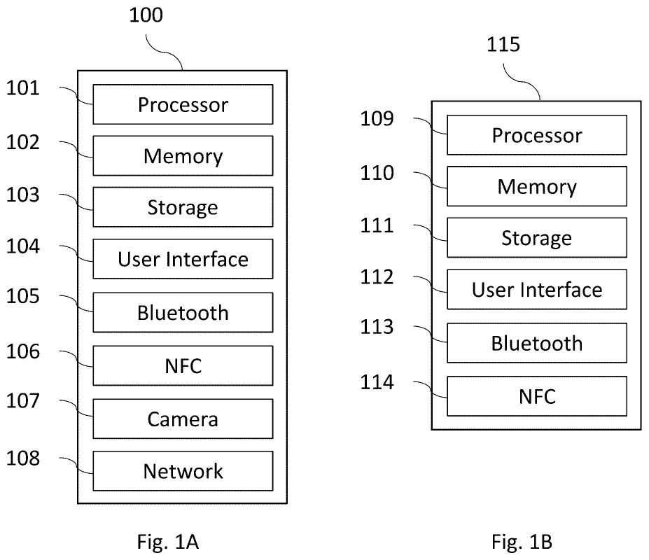

FIGS. 1A and 1B schematically show example data processing apparatuses 100 and 115. FIG. 1A shows a first data processing apparatus 100. The apparatus 100 comprises a processor 101 for executing electronic instructions, a memory 102 (e.g. volatile memory) for storing the electronic instructions to be executed and electronic input and output information associated with the electronic instructions, a storage medium 103 (e.g. non-volatile memory) for long term (persistent) storage of information, a user interface 104 (e.g. a touch screen and/or one or more buttons) for receiving commands from and/or outputting information to a user, a Bluetooth interface 105 for sending information to and/or receiving information from one or more other apparatuses (e.g. second data processing apparatus 115) via Bluetooth (e.g. via any suitable existing Bluetooth standard(s), including Bluetooth Low Energy (BLE)), a near-field communication (NFC) interface 106 for sending information to and/or receiving information from one or more other apparatuses (e.g. second data processing apparatus 115) via NFC (e.g. via any suitable existing NFC standard(s)), a camera 107 for capturing digital images and a network interface 108 for sending information to and/or receiving information from one or more other apparatuses (e.g. via a network such as the internet).

Each of the processor 101, memory 102, storage medium 103, user interface 104, Bluetooth interface 105, NFC interface 106, camera 107 and communication interface 108 are implemented using appropriate circuitry, for example. The processor 101 controls the operation of each of the memory 102, storage medium 103, user interface 104, Bluetooth interface 105, NFC interface 106, camera 107 and communication interface 108.

The data processing apparatus 100 may be referred to as a scanning apparatus/device (or scanner) and, in the following non-limiting examples, is a suitably configured smartphone.

FIG. 1B shows a second data processing apparatus 115. The apparatus 115 comprises a processor 109 for executing electronic instructions, a memory 110 (e.g. volatile memory) for storing the electronic instructions to be executed and electronic input and output information associated with the electronic instructions, a storage medium 111 (e.g. non-volatile memory) for long term (persistent) storage of information, a user interface 112 (e.g. a touch screen, one or more buttons and/or one or more motion sensors for detecting the apparatus 115 being, for example, picked up or shaken) for receiving commands from and/or outputting information to a user, a Bluetooth interface 113 for sending information to and/or receiving information from one or more other apparatuses (e.g. first data processing apparatus 100) via Bluetooth (e.g. via any suitable existing Bluetooth standard(s), including BLE) and an NFC interface 106 for sending information to and/or receiving information from one or more other apparatuses (e.g. first data processing apparatus 100) via NFC (e.g. via any suitable existing NFC standard(s)).

Each of the processor 109, memory 110, storage medium 111, user interface 112, Bluetooth interface 113 and NFC interface 114 are implemented using appropriate circuitry, for example. The processor 109 controls the operation of each of the memory 110, storage medium 111, user interface 112, Bluetooth interface 113 and NFC interface 114.

The data processing apparatus 115 may be referred to as a communication apparatus/device. The communication apparatus may be, in particular, a beacon apparatus/device (or beacon) and, in the following non-limiting examples, is a BLE beacon.

In the following example(s), the scanning device 100 is controlled to a perform a Bluetooth operation to obtain an identifier from each of one or more beacon devices 115. However, the present technology is not limited to this and, more generally, other Bluetooth operations (e.g. comprising the transmission of another type of information from the scanning device 100 to one or more beacon devices 115 or vice versa) are envisaged.

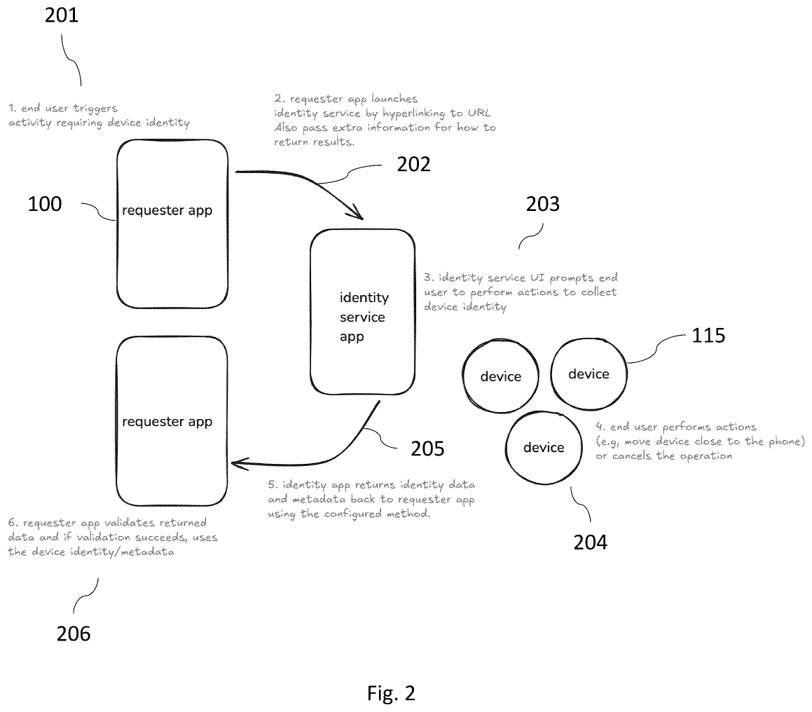

FIG. 2 shows an example process according to the present technology which allows identifiers (e.g. UUIDs) of one or more beacon devices 115 to be detected by a requester software application (requester app) executed on a scanning device 100. The scanning device 100 and one or more beacon devices 115 form an example system.

In an example, each beacon device is a sensor device configured to transmit sensor data collected by a sensor (not shown) of the beacon device (e.g. data indicative of a detected temperature if the sensor is a temperature sensor, data indicative of a detected luminance if the sensor is a light sensor, etc.) and the requester app is a software application which provides a service of collecting and monitoring the received sensor data. In an example, the sensor data is transmitted via the Bluetooth interface 113 of each beacon device 115 and via the Bluetooth interface 105 of the scanning device 100. Before monitoring of the sensor data by the requester app can start, however, the requester app needs to know which beacon devices (i.e. which beacon device identifiers) it should be collecting sensor data from. Beacon device identifiers (which are an example of device identity information) thus need to be registered with the requester app.

Existing solutions involve the requester app executing its own functionality to enable the collection of beacon device identifiers (IDs). However, as mentioned, this may lead to performance, user experience, security and/or complexity issues. The present technology thus alleviates this problem by allowing the requester app to outsource the collection of beacon device data (including an identifier of each beacon device and, optionally, additional data (metadata) transmitted by each beacon device) to an identity service software application (identity service app). The identity service app is a separate app executed on the scanning device 100 provided by an identity service provider. The identity service provider is a specialist in implementing the collection of beacon device data and the identity service app thus allows such data to be collected in a fast, secure and easy-to-use way. Such collected data can then be used by the requester app to provide the relevant service (e.g. collection and monitoring of sensor data).

The process of FIG. 2 comprises a plurality of steps.

At step 201, an end user of the requester app triggers a process for collecting beacon device identities. For example, if the requester app is for collecting temperature sensor data from temperature-sensing beacon devices distributed around machinery of a factory, the requester app first needs to collect the unique identifier (e.g. UUID) of each beacon device from which it expects to receive temperature sensor data. The trigger comprises the user selecting a virtual “Add Devices” button displayed by a graphical user interface (GUI) the requester app, for example.

At step 202, in response to the trigger, the requester app causes the identity service app to be launched.

In an example, the requester app opens a request uniform resource locator (URL) such as an App Link or Universal Link which controls an operating system (OS) of the scanning device 100 (e.g. iOS® or Android®) to cause the identity service app to open (that is, to cause a GUI of the identity service app to be displayed on screen so it can receive inputs from the user).

Suitable information is included in the request URL to facilitate the collection of beacon device data. For example, the request URL may comprise a callback URL. A callback URL (which is an example of a response URL), which may be another App Link or Universal Link, for example, controls the scanning device OS to cause the requester app to re-open (that is, to cause the GUI of the requester app to once again be displayed on screen in so it can receive inputs from the user).

The request URL may also comprise context data. The context data comprises, for example, validation data such as a unique and/or randomly generated token generated by the requester app. This enables the requester app to later validate beacon device data received from the identity service app.

Additional context data may also be provided in the request URL (e.g. as one or more additional attributes of the request URL). For example, additional context data may comprise an indicator for use in authenticating that a beacon device is genuine (as explained later). In another example, additional context data may comprise information about the current interaction session between the requester app and identity service app. For instance, it may indicate a user identifier of the user of the requester app initiating the request or an identifier of the request itself (thereby allowing repeat requests to be identified and discarded).

The request URL may also comprise scan mode data. The scan mode data indicates, to the identity service app, a desired one of a plurality of methods of obtaining the beacon device data from each beacon device 115. This causes the identity service app to control the scanning device 100 to perform a scan accordingly. For example, the scan mode data may indicate one of a “proximity scan”, “announce button scan” or “scan and select” mode. Each of these modes involves controlling the Bluetooth interface 105 to scan for BLE advertising packets transmitted by beacon device(s) comprising respective beacon device data.

The proximity scan mode obtains beacon device data from beacon device(s) within a certain proximity to the scanning device 100. Such beacon device(s) may be those associated with a proximity-related signal parameter (e.g. a received signal strength indicator (RSSI)) of BLE advertising packet(s) transmitted by those beacon device(s)) exceeding a predetermined threshold, for example.

The announce button scan mode obtains beacon device data from beacon device(s) which have had an announce function activated. The announce function of a beacon device is activated by pressing an announce button or the like of the beacon device to cause the beacon device to include an announce indicator (e.g. a flag) in BLE advertising packets transmitted by that beacon device. The scanning device 100 then only obtains beacon device data from beacon device(s) including such an indicator.

The scan and select mode obtains beacon device data from all beacon device(s) from which BLE advertising packet(s) are received. The user may then perform a selection operation on one or more of the detected beacon device(s).

At step 203, based on the request URL, a GUI of the identity service app prompts the user to perform any necessary predetermined action (process) for collecting the beacon device data. This is dependent on the scan mode data indicated by the request URL, for example. Thus, for instance, if the scan mode is the announce button scan mode, the identity service app may prompt the user to activate a button on the beacon device 115 to be registered (or, if the beacon device comprises a motion sensor, to pick up or shake the beacon device) which causes the beacon device to transmit one or more BLE advertising packets comprising the beacon device data. If the scan mode is the proximity scan mode, the identity service app may prompt the user to bring the scanning device 100 and beacon device 115 to be registered into sufficient proximity with each other.

At step 204, the user performs the action prompted at step 203 and the beacon device data is obtained. The service identifier app GUI also provides a cancel option (e.g. virtual “cancel” button) to cancel the scan. Activation of the cancel option causes the OS to re-open the requester app (e.g. using a callback URL comprising a portion (attribute) indicating the cancel option has been activated) and once again display the original screen of the requester app GUI (e.g. that comprising the virtual “Add Devices” button) without completing the registration of any beacon devices.

At step 205 (assuming the user performs the prompted action and does not activate the cancel option), the obtained beacon device data is returned to the requester app. This involves, for example, the identity service app customising the callback URL by adding the beacon device data as appropriate attribute(s) of the callback URL. The context data is also added as an attribute of the callback URL. The customised callback URL is then opened by the identity service app to cause the OS to re-open the requestor app.

At step 206, the requester app validates the received beacon device data and, once validated, registers the device ID of the received beacon device data for use with the service provided by the requester app. Thus, for example, if the registered beacon device comprises a temperature sensor and transmits detected temperature data in BLE advertising packets comprising the device ID, the service knows to store and monitor the detected temperature data received from that particular beacon device and to enable the user to manage the beacon device via the requester app (e.g. to add or remove the beacon device from a list of favourites or view stored historical detected data received from the device). Temperature data is an example of operational data (e.g. data collected by a sensor of the registered beacon device) and is distinguished from metadata (e.g. data about the device provided with the device ID during registration, such as a manufacturer, model and/or current battery level of the device).

The validation of the received beacon device data comprises comparing the context data (e.g. unique and/or randomly generated token) in the callback URL with the context data provided in the request URL. If there is a match, this confirms to the requester app that the beacon device data has genuinely been received from the identity service app, thereby helping improve security. For example, this helps prevent unwanted or malicious device IDs from being registered with the requester app.

In a further example, the validation comprises a beacon device itself being authenticated using the context data. For example, if it is desired for the requester app to only be able to register specific beacon device(s) (e.g. those with a predetermined characteristic, such as those specifically manufactured for a particular organisation) using the identity service app, the requester app may include, as additional context data in the request URL, a signal (e.g. a flag) which controls the identity service app to cause the scanning device 100 to transmit the context data (in particular, the unique and/or randomly generated token of the context data) to a beacon device to be registered so the beacon device may encrypt the context data using a private key associated with the beacon device and transmit the encrypted context data back to the scanning device 100. The encrypted context data is then returned to the requester app in the callback URL (e.g. in an additional attribute of the callback URL) and the requester app attempts to decrypt the encrypted context data using a corresponding public key to the private key. The private key is known only to the specific beacon device(s) which are intended for registration with the requester app. If the decrypted context data matches the original context data included in the request URL, the requester app knows that the device ID received via the callback URL has been genuinely received from identity service app and is a device ID of one of the specific beacon device(s) which are intended to be registered. The context data is thus an example of first validation data and the encrypted context data an example of second validation data derived from the first validation data for enabling the requester app to validate information received from a beacon device via the callback URL.

In an example (e.g. when the proximity scan or announce button scan mode is used to register one beacon device at a time), the steps 201 to 206 of FIG. 2 are repeated for each of the three beacon devices 115 to register each beacon device (via its corresponding unique device ID) with the requester app.

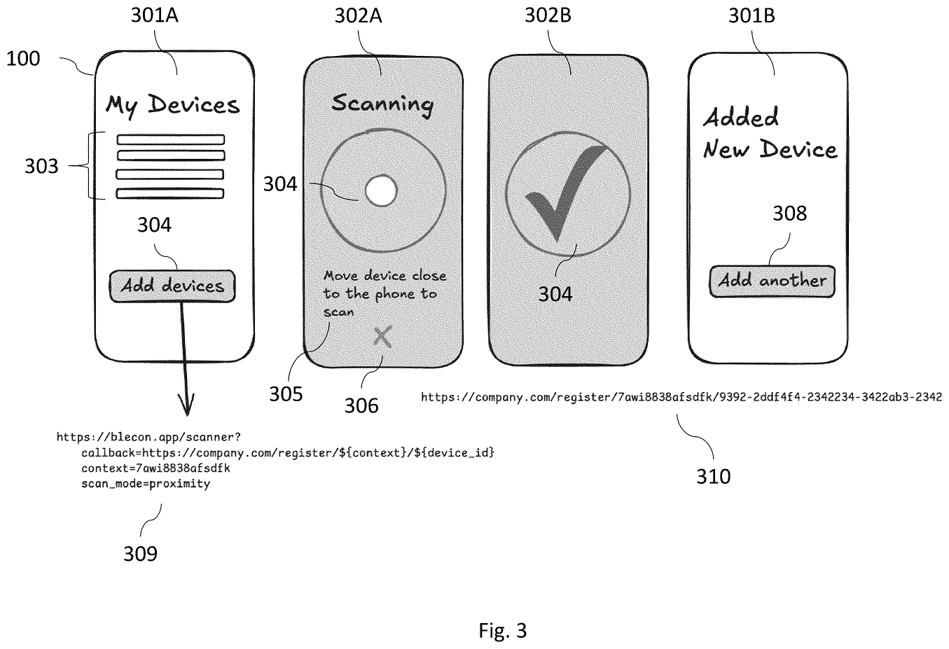

FIG. 3 shows example GUI screens of the requester app and identity service app. Example request and callback URLs are also shown.

Screen 301A is a first screen of the requester app. Screen 301A shows a list 303 of beacon devices whose device IDs have already been registered with the requester app. Screen 301A also comprises a virtual “Add Devices” button 304 which triggers the requester app to open the request URL (e.g. step 201 above).

An example request URL 309 is shown. The request URL comprises a plurality of attributes.

A first attribute “callback” defines the callback URL.

A second attribute “context” defines the context data. In this example, the context data is a unique and/or random token “7awi8838afsdfk”.

A third attribute “scan_mode” defines the scan mode data. The scan mode data takes one of a plurality of predetermined values indicative of different respect scanning modes (e.g. “proximity” for the proximity scan mode, “announce_button” for the announce button scan mode or “scan_select” for the scan and select mode). In this example, the scan mode is the proximity scan mode.

The defined callback URL itself also comprises one or more attributes which are customisable by the identity service app to generate the customised callback URL. In this example, these are $ {context} and $ {device_ID}. When generating the customised callback URL, the attribute $ {context} is set as the context data (“7awi8838afsdfk” in this example) and the attribute $ {device_id} is set as the device ID of the beacon device to be registered.

Screen 302A is a first screen of the identity service app. Screen 302A is displayed in response to the requester app opening the request URL (e.g. step 202 above) and shows displayed information 305 prompting the user to perform an action necessary for collecting the device ID of the beacon device 115 to be registered (e.g. step 203 above). In this case, since the scan mode is the proximity scan mode, the information 305 prompts the user to move the beacon device 115 to be registered close to the scanning device 100. The user may also cancel the scan by selecting the virtual “cancel” button 306.

Screen 302A also shows changeable icon 304. The appearance of icon 304 initially takes a first form on screen 302A when the identity service app begins a scanning function (but before the device ID of the beacon device to be registered has been obtained (e.g. because the beacon device is not yet close enough to the scanning device 100). The appearance of icon 304 then changes to a second form in response to the device ID being obtained (e.g. once the beacon device is moved within sufficient proximity to the scanning device, e.g. step 204 above). This is shown on screen 302B, which is a second screen of the identity service app. This allows the user to easily recognise when the identity service app has acquired the device ID of the beacon device as they move the scanning device 100 and beacon device 115 relative to each other.

Screen 301B is a second screen of the requester app displayed in response to the identity service app opening the customised callback URL and the beacon device data being validated (e.g. steps 205 and 206 above) by the requester app. The screen 301B confirms that the beacon device has been registered and shows another virtual “Add Another” button 308. Activation of virtual button 308 re-initiates steps 201 to 206 for the registration of further beacon devices 115. Although not shown, the screen 301B may also display the device ID of the newly registered beacon device together with any metadata received with the device ID, for example.

An example of the customised callback URL 310 is shown. As can be seen, the customised callback URL has the same format as defined by the “callback” attribute of the request URL but the customisable attributes $ {context} and $ {device_ID} have been customised to define, respectively, the context data (“7awi8838afsdfk” in this example) and the detected device ID of the beacon device to be registered (“9392-2ddf4f4-2342234-3422ab3-2342” in this example). The customised callback URL 310 thus allows the requester app to obtain and store (that is, register) the device ID (for later use with the service provided by the requester app) and the context data to validate the received device ID.

The callback URL may also comprise other customisable attributes for obtaining other metadata collected from the beacon device by the identity service app during the scan. Such customisable attributes are defined in the request URL by the requester app. This provides improved flexibility by allowing different requester apps (associated with different third party services, for example) to obtain and store different metadata from beacon devices depending on the needs of the service.

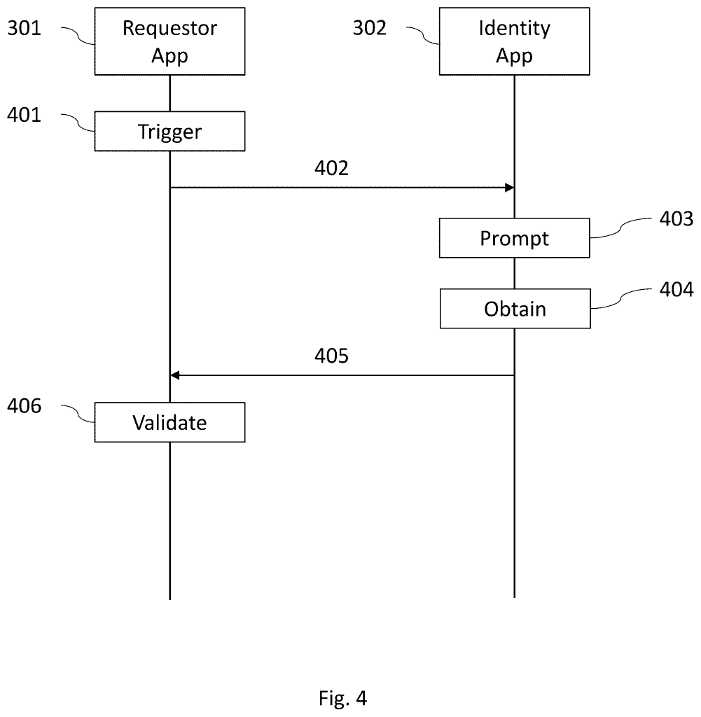

FIG. 4 shows an example data flow between the requester app 301 and identity service app 302, as executed by the scanning device 100.

At step 401, a trigger is detected by the requester app 301 (e.g. by a user activating the virtual “Add Devices” button 304 or virtual “Add Another” button 308).

At step 402, a request is passed from the requester app 301 to the identity service app 302. The request is a request for the identity service app to perform a scan to obtain the beacon device data (including the device ID and, optionally, device metadata) of a beacon device 115 to be registered with the requester app for provision of a service associated with the requester app. In the above examples, executing the request comprises opening the request URL which causes the service identity app to open. The request may include the passing of information such as context data (for validation) and scan mode data (to indicate the type of scanning to be executed under control of the identity service app) to the identity service app.

At step 403, the service identity app prompts the user to perform a predetermined action for enabling the beacon device data to be obtained. For example, the user is prompted to bring the scanning device 100 and beacon device 115 to be registered into sufficiently close proximity to each other (e.g. as exemplified by prompt 305 of screen 302A).

At step 404, the service identity app 302 obtains the beacon device data and, at step 405, passes a response back to the requester app 301. In the above examples, executing the response comprises opening the callback URL which causes the requester app to open. The response includes the passing of the obtained beacon device data back to the requester app. The response may also include the passing of other information such as the context data (provided with the request at step 402) back to the requester app (for validation). In other words, the requester app is therefore able to access the beacon device data (and any other information).

At step 406, the received beacon device data is validated (e.g. by ensuring there is a match between the context data of the request and the context data of the response). The beacon device data is then stored for use by the requester app in providing the service associated with the requester app. In particular, since the beacon device data (including device ID) is now stored for use by the requester app 301, the requester app is able to identify data transmissions received by the scanning device 100 from the beacon device 115 associated with that beacon device data without further involvement of the identity service app 302. Such data transmissions are, for example, BLE advertising packets comprising the device ID. The requester app may then, for example, control the scanning device 100 to establish a BLE connection with the beacon device 115 to enable data (e.g. sensor data) collected by the beacon device to be transmitted to the scanning device 100. The requester app may then control the scanning device to process and/or transmit the sensor data to a server (not shown) to deliver the service associated with the requester app (e.g. collecting, monitoring and processing the collected sensor data).

The requester app may also share the obtained beacon device data with other devices associated with the service with which the requester app is associated (e.g. a server and/or other devices on which the requester app installed). This allows one device with the requester app to register a new beacon device but then any device associated with the service to receive subsequent data transmissions from that beacon device.

The present technology thus provides a quick, easy and secure way for a requester app to obtain device IDs (and, optionally, additional metadata) of beacon devices to be used for providing a service associated with the requester app. The requester app developer thus does not need to include any functionality for beacon device detection, since this is handled by the identity service app. Rather, for example, all the requester app developer must do is configure the requester app to generate and open a request URL and to open in response to and obtain relevant data from a subsequent callback URL. The service identity app then efficiently and securely handles the functionality (e.g. scanning and prompting of the user and doing so using any appropriate security protocol(s)) for actually obtaining the relevant beacon device IDs. Furthermore, it does this with a GUI providing a consistent and easy to use user experience (which is the same no matter which requester app uses it).

It will be appreciated the functionality of the requester app may be software (in particular, a software application) implemented in any suitable form, such as an iOS or Android mobile app, a desktop application (e.g. Windows® or Mac OS® application), webpage or progressive web application. The requester app may thus be referred to more broadly as a requester (or requester software code, this being an example of first software code). Similarly, the functionality of the identity service app may be software (in particular, a software application) implemented in any suitable form, such as an iOS or Android mobile app, a desktop application, webpage or progressive web application configured to access the Bluetooth interface 105 of the scanning device 100. The identity service app may thus be referred to more broadly as an identity service (or identity service software code, this being an example of second software code).

Although the request and response in the above-mentioned examples are implemented as URLs, the present technology is not limited to this. Rather, any suitable method for passing requests and responses between the requester and identity service executed on the scanning device 100 may be used. For example, the requester and identity service may communicate via local inter-process communication (IPC, e.g. sockets, D-Bus, or the like), via a network (e.g. via remote procedure call (RPC), Hypertext Transfer Protocol (HTTP) request(s) (in particular, HTTP GET and/or POST request(s)), via the use of a browser extension or plugin application programming interface (API), via App Links or Universal Links or via a URL scheme handler.

Moreover (and as explained below), the requester may comprise a frontend (e.g. provided by the requester app executed on the scanning device 100) and a backend (e.g. provided by a remote server apparatus in communication with the scanning device). In this case, for example, the functionality of the identity service app may be invoked by the frontend using a request URL (as described above). Beacon device data obtained from beacon device(s) 115 by the identity service app may then be returned to the backend using, for example, a suitable HTTP request (e.g. an HTTP GET or POST request) and/or suitable API (e.g. WebSocket API).

The request generated by the requester may also indicate additional information to the identity service. For example, this may be provided as additional attribute(s) of a request URL. The functionality of the identity service is then adjusted based on the additional information. This helps provide improved flexibility to requester app developers in configuring how the identity service operates.

Examples of additional information that could be indicated by the request include a make and/or model of beacon devices to detect (e.g. so the identity service only returns device IDs of beacon devices matching that make and/or model), a unique and/or random token (as exemplified above), an indication of how the response is to be provided (e.g. by providing a callback URL, as exemplified above), an indication of a cryptographic challenge to be completed by the identity service and/or beacon device(s) to be registered, an instruction regarding an appearance and/or content of the identity service GUI (e.g. the inclusion of help messages or the like to assist with scanning) and/or an authentication token (e.g. digital signature associated with the requester so the requester can be verified).

Regarding an indication of a cryptographic challenge, this may comprise, for instance, a trigger to cause the identity service to invoke an OS-based request for a password or biometric input from the user before scanning can commence. Alternatively, or in addition, it may comprise a trigger to cause the beacon device(s) to be registered to display information (e.g. a random number, assuming the user interface 112 of the beacon device 115 comprises a display) which must then be entered or confirmed by the user of the scanning device 100 before the beacon device data is returned to the requester. This helps provide improved security.

The cryptographic challenge may also be set by the requester itself. In this case, for example, the request indicates the cryptographic challenge (e.g. causing the identity service to ask for a password) and the response indicates the cryptographic response (e.g. the password entered by the user via the identity service). The requester then only allows use of obtained beacon device data if the correct cryptographic response has been provided (otherwise, for example, the obtained beacon device data is deleted). Again, this helps provide improved security and provides more control to the requester (e.g. by enabling a password of a user account of the service associated with the requester to be used rather than, for instance, an OS password).

Although the above examples show the collection of beacon device data from a single beacon device at a given time (e.g. by repeating the cycle of steps 201 to 206 for each respective single beacon device to be registered), beacon device data from multiple beacon devices may also be collected (e.g. at step 204) and/or returned (e.g. at step 205) during a single cycle. For instance, in the scan and select mode, the identity service may collect beacon device data from all beacon devices detected within a predetermined period of time (e.g. 10, 20 or 30 seconds). The user may then be presented with a list of detected beacon devices and select one or more of those devices whose beacon device data should be returned to the requester. In an example, only beacon device data of a subset of detected devices meeting predetermined requirements (e.g. those of a certain make and/or model) associated with the requester (the requester being verifiable by the inclusion of an authentication token, such as digital signature, indicated by the request) may be collected and returned to the requester by the identity service.

In an example, when the beacon device data of multiple beacon devices is obtained by the identity service and returned to the requester in a single cycle, the response (e.g. URL response) indicates the beacon device data of each of the multiple beacon devices (e.g. as a string with the beacon device data associated with different beacon devices being separated by a predetermined character such as an underscore “_”).

The response generated by the identity service may also indicate additional information to the requester (e.g. in response to additional information indicated in the request). For example, this may be provided as additional attribute(s) of a callback URL. For instance, as well as the beacon device ID(s), the response may indicate a response to a cryptographic challenge (e.g. requester service account password entered by a user or an indication that the OS password was entered correctly), a description of the device, a unique manufacturer-defined field identifier and/or a unique and/or random token (e.g. as indicated by the request as context data). As previously mentioned, if the scanning is cancelled (e.g. by the user activating the virtual cancel button 306), the response indicates the cancellation.

There are many potential use cases of the present technology. As non-limiting examples, these could include the adding of beacon devices to a Blecon® network associated with the requester, allowing an end-user to associate a new beacon device (e.g. purchased at a store) with an account they have with a service associated with the requester or using an obtained device ID to lookup (e.g. using the service associated with the requester) to query a history of readings of a sensor comprised in (or connected to) a specific beacon device. It will be appreciated the technical solution of the present technology may be applicable to any situation in which a service needs to obtain a device ID associated with a beacon device for use of the beacon device by that service.

It is also noted that the present technology is applicable more generally to using a URL to allow a first software application running on a first device (e.g. scanning device 100) to communicate with a second device (e.g. beacon device 115) via a second software application which controls the first device (or another device in communication with the first device) to perform Bluetooth operation(s) (including classic Bluetooth or BLE communication) with the second device. This enables the first software application to communicate with the second device via Bluetooth using only an appropriate URL (such as the described request URL). For example, the first software application is a local, non-browser, software application (e.g. locally installed requester app) or a web browser accessing a webpage (e.g. a webpage of a web application such as a web-based requester app). The second software application is the identity service app (which also runs on the first device).

This allows developers of entities such as web pages, web-based software applications or locally-installed software applications to more quickly and easily implement a capability of such entities to control the first device on which they are being output or run to communicate with a second, different, device (in particular, a Bluetooth device), since such developers do not need to code this capability in the entity themselves. Rather, all that is required is that the entity is coded to open a first URL (e.g. request URL) which causes a second software application (e.g. identity service app) to perform a Bluetooth operation with the second device. The second software application then returns information received from the second device (e.g. the device ID of the second device) via Bluetooth back to the entity (e.g. by opening a second URL (e.g. callback URL or by communicating the information to a backend server of the entity).

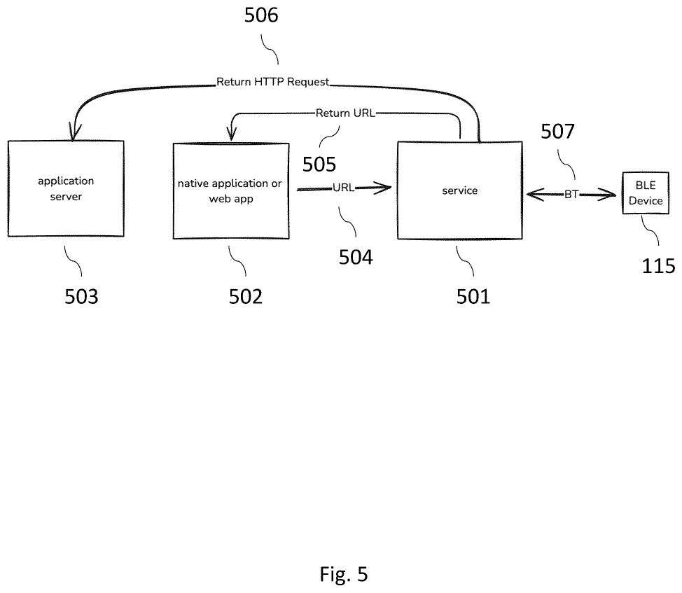

FIG. 5 thus shows a more general example of the present technology.

The service 501 and native application or web app 502 are software applications executed using the scanning device 100. An example of the service 501 is the identity service app 302. An example of the native application or web app 502 is the requester app 301. In the case of a web app, the web app is executed using a web browser of the scanning device. The app 502 controls the scanning device 100 (e.g. via the OS of the scanning device 100) to perform Bluetooth operation(s), in particular Bluetooth operation(s) to send signal(s) to and/or receive signal(s) from one or more beacon devices 115. For example, the app 502 controls the scanning device 100 to receive beacon device data (including the device ID) from each beacon device 115. In this example, the beacon device 115 is a BLE beacon device. The Bluetooth operation(s) thus comprise sending signal(s) to and/or receiving signal(s) from the beacon device 115 via BLE operation(s) (e.g. receiving beacon device data in a BLE advertising packet, a BLE advertising packet being an example of a signal).

The application server 503 is a server serving the app 502 (e.g. so the server 503 provides backend functionality and the app 502 provides frontend functionality). For example, the app 502 may be configured to transmit requests and receive responses from the server 503. The server 503 and scanning device 100 may thus communicate with each other (e.g. over a network (not shown) such as the internet).

The service 501 is configured to perform the Bluetooth operation(s) in response to the app 502 opening a URL 504. The URL is a request URL with a format as previously described, for example. Information associated with the Bluetooth operation(s) is then shared with the app 502 and/or the server 503. The shared information includes information derived from Bluetooth signal(s) received from the beacon device(s) 115, for example. For example, it includes beacon device data including a device ID of each beacon device.

The information is shared with the app 502 via a return URL 505 (e.g. callback URL identified by the URL 504, as previously described). The information is shared with the server 503 via an HTTP request or suitable API. In this example, an HTTP request 506 (e.g. HTTP GET or POST request) is used. In an example, the URL 504 may indicate the HTTP request 506 (or at least a URL of the HTTP request) in a similar way to that described for indicating the callback URL. That is, the HTTP request (or URL of the HTTP request) may be indicated as an attribute of the URL 504. The HTTP request (or URL of the HTTP request) may also include context data indicated by the URL 504 for validation of the HTTP request by the server 503 (e.g. using the same validation techniques as previously described for validation by the requester app). Information shared with the server 503 may be obtained by the app 502 using one or more further HTTP requests and responses (not shown), for example.

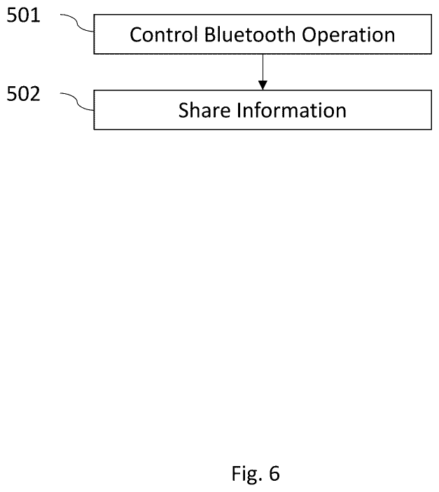

FIG. 6 shows an example method. The method is executed by the processor 101 of the scanning device 100 under control of the service 501, for example.

At step 501, in response to opening of a URL (e.g. URL 504) by a software application (e.g. app 502) executed by the scanning device 100, the scanning device 100 is controlled to perform a Bluetooth operation.

At step 502, information associated with the Bluetooth operation is shared with the software application or a server apparatus (e.g. server 503) of the software application.

Example(s) of the present disclosure are defined by the following numbered clauses:

1. A computer-implemented method for controlling a data processing apparatus, the method comprising:
controlling, in response to opening of a uniform resource locator, URL, by a software application executed by the data processing apparatus, the data processing apparatus to perform a Bluetooth operation; and
sharing information associated with the Bluetooth operation with the software application or a server apparatus of the software application.

2. A computer-implemented method according to claim 1, wherein:
the Bluetooth operation comprises receiving, via Bluetooth, a signal from a second data processing apparatus; and
the shared information comprises information derived from the received signal.

3. A computer-implemented method according to claim 2, wherein the signal received from the second data processing apparatus comprises identity information of the second data processing apparatus and the shared information comprises the identity information.

4. A computer-implemented method according to claim 2 or 3, wherein the signal received from the second data processing apparatus is a Bluetooth Low Energy, BLE, advertising packet.

5. A computer-implemented method according to any preceding claim, wherein the URL is a first URL and the shared information is shared by opening a second URL indicating the shared information.

6. A computer-implemented method according to claim 4, wherein the second URL is indicated by the first URL.

7. A computer-implemented method according to any one of claims 4 to 6, wherein the first URL indicates first validation data and the second URL indicates second validation data derived from the first validation data for enabling validation of the shared information.

8. A computer-implemented method according to any one of claims 5 to 7, wherein the second URL is a URL for opening the software application.

9. A computer-implemented method according to any one of claims 5 to 7, wherein the second URL is a URL of a HyperText Transfer Protocol, HTTP, request and the method comprises controlling the data processing apparatus to transmit the HTTP request to the server apparatus.

10. A computer program for controlling a data processing apparatus to perform a computer-implemented method according to any preceding claim.

11. A computer-readable storage medium storing a computer program according to claim 10.

12. A data processing apparatus comprising circuitry storing a computer program configured to:
control, in response to opening of a uniform resource locator, URL, by a software application executed by the data processing apparatus, the data processing apparatus to perform a Bluetooth operation; and
share information associated with the Bluetooth operation with the software application or a server apparatus of the software application.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

1. A computer-implemented method for controlling a data processing apparatus, the method comprising:
controlling, in response to opening of a uniform resource locator, URL, by a software application executed by the data processing apparatus, the data processing apparatus to perform a Bluetooth operation; and
sharing information associated with the Bluetooth operation with the software application or a server apparatus of the software application.

2. A computer-implemented method according to claim 1, wherein:
the Bluetooth operation comprises receiving, via Bluetooth, a signal from a second data processing apparatus; and
the shared information comprises information derived from the received signal.

3. A computer-implemented method according to claim 2, wherein the signal received from the second data processing apparatus comprises identity information of the second data processing apparatus and the shared information comprises the identity information.

4. A computer-implemented method according to claim 2, wherein the signal received from the second data processing apparatus is a Bluetooth Low Energy, BLE, advertising packet.

5. A computer-implemented method according claim 1, wherein the URL is a first URL and the shared information is shared by opening a second URL indicating the shared information.

6. A computer-implemented method according to claim 4, wherein the second URL is indicated by the first URL.

7. A computer-implemented method according to claim 4, wherein the first URL indicates first validation data and the second URL indicates second validation data derived from the first validation data for enabling validation of the shared information.

8. A computer-implemented method according to claim 5, wherein the second URL is a URL for opening the software application.

9. A computer-implemented method according to any one of claim 5, wherein the second URL is a URL of a HyperText Transfer Protocol, HTTP, request and the method comprises controlling the data processing apparatus to transmit the HTTP request to the server apparatus.

10. A computer program for controlling a data processing apparatus to perform a computer-implemented method according to claim 1.

11. A computer-readable storage medium storing a computer program according to claim 10.

12. A data processing apparatus comprising circuitry storing a computer program configured to:
control, in response to opening of a uniform resource locator, URL, by a software application executed by the data processing apparatus, the data processing apparatus to perform a Bluetooth operation; and
share information associated with the Bluetooth operation with the software application or a server apparatus of the software application.
